(19) United States
(12) Patent Application Publication
(10) Pub. No.: US 2002/0029490 A1
(43) Pub. Date: Mar. 14, 2002

(54) Body dryer method and apparatus

(76) Inventor: Richard T. Lundquist, Bow, WA (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/843,047

(22) Filed: Apr. 25, 2001

Related U.S. Application Data
(60) Provisional application No. 60/199,473, filed on Apr. 25, 2000.

(51) Int. Cl. F26B 19/00

(52) U.S. Cl. 34/90

(57) ABSTRACT

An air drying system where compress air is injected at a high velocity through a slot to form an “air knife”. This eliminates the need for towels to dry individuals after exiting a shower or the like. The air has a sufficient velocity so that a portion of the water is actually blown of the surface of the person's skin. Further, the air is heated, thus adding energy to the water droplets and drying the surface water more effectively.

### SUMMARY OF THE INVENTION

The invention relates to an air drying system and method that removes the need for towels to dry individuals after exiting a shower or the like.

The invention utilizes turbo blower/pump forced air that is ejected at a high velocity upon a wet individual to sufficiently dry the individual in a reasonable amount of time. The invention has advantages of removing the need for towels in locker room environments. This will cut down disease transfer and resources used washing towels. There are further economic benefits when using the preferred embodiment of the present invention of removing the costly need for washing a high quantity of towels. The rising costs for bleach and hot water and the washing equipment to meet codes can be cost prohibitive. The invention is particularly advantageous in environments where a high quantity of individuals must be dried off after showering.

The present invention is particularly advantageous in dry climates and areas where the building housing the invention requires general heating. The heat from the heat elements can et spillover benefits in heating the entire establishment. However, the apparatus of the present invention also functions well in warm environments because the ΔT (temperature difference between the ambient air and the ejected air from the air knife) is lower and hence requires less energy to heat the flowing air for a comfortable air stream. Further, the present invention is particularly advantageous in institutions such as military camps and jails or prisons, schools or any other institutional setting. In these groups settings were comfort is not an objective the heater unit can insert a less amount of heat into the airflow stream to save money. The apparatus of the present invention utilizes the concept of blasting water off of the skin of an individual in addition to the regular evaporating process.

### BRIEF DESCRIPTION OF THE DRAWINGS

FIG. 1 shows an isometric view of the apparatus of the present invention where the air knife extrusion is exposed;

FIG. 2 shows an isometric view of the blower and heating assemblies that are generally not visible to the end users;

FIG. 3 shows a second embodiment of the present invention;

FIG. 4 shows a side view of a second embodiment of the present invention where two air knifes are employed.

### DETAILED DESCRIPTION OF PREFERRED EMBODIMENTS OF THE PRESENT INVENTION

As seen in figure is one and two, the apparatus of the present invention 20 comprises an air knife 22, a control interface 24, a heater assembly 26, a blower 28, and a processor (not shown).

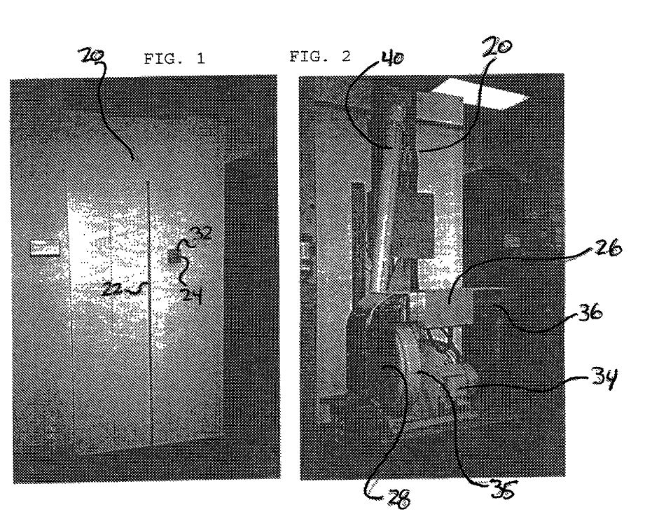

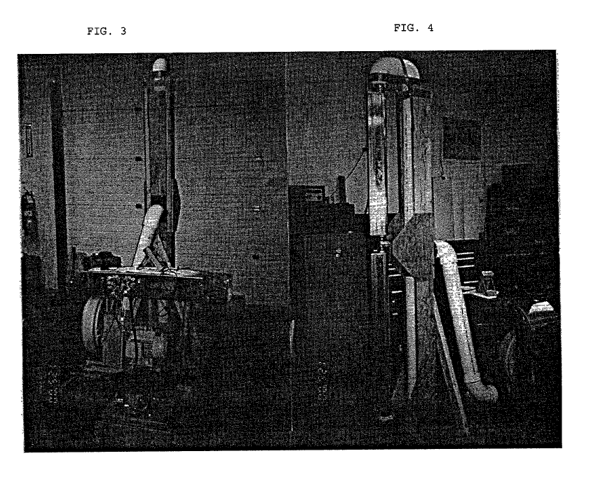

The general operations of the apparatus 20 are as follows. First the individual exits the shower (not shown) and presses the button 32 on the control interface 24. This sends a signal to the processor to begin a drying sequence. The processor starts a countdown timer and turns on the turbo blower/pump 28 and the heater 26. As seen in FIG. 2, the turbo blower/pump 28 draws in air through the duct 36 and through heating elements 26. The air then passes through the turbo blower/pump 28 and up through the piping 40. Thereafter it is directed through the air knife 22 where the air is impacted upon the individual. A common cycle would last for about a 1 1/2 minutes to about 2 1/2 minutes. After this period of time the timer cuts the power to the heating element 26 and the blower 28.

The blower apparatus comprises a motor 34, a duct system 36, a turbo blower/pump 38 and tubing 40. The heater 26 is in series in the ducting system 36. As the heat passes through the duct 36 it travels through heating elements contained therein. It should be noted that the blower/pump 38 not only produces a high cubic feet per minute transfer of air but further can produce a significant static pressure difference. Therefore the static pressure of the air after the blower/pump 38 is approximately in the range of 18 to 20 inches of water. A less preferable range but functional would be 18 to 24 to provide greater pressure and hence greater volumetric flow and ejection speeds. This high pressure range advantageous for producing a high velocity air stream that is ejected from the air knife 22 which is further discussed herein.

The air knife 22 can be one that is commonly used in part drying operations. One common manufacture is Fuji™. The air knife in FIG. 1 is approximately six and a half feet in vertical length and can eject air at speeds of around 90-120 mph.

When the air molecules impact upon water located on an individual's skin surface several physical principles are occurring. First, the high velocity of air is literally blowing the water droplets (while still in a liquid state) off of the individual. Secondly, the heated air is adding energy to the water droplets and hence evaporating them. Thirdly, the high velocity is replacing the immediate boundary immediately surrounding the water droplets. This force convection increases the diffusion of the water molecules and hence increases the evaporation process. Presumably, the water droplets then travel to the floor and run down a conventional drain.

The heating element can be of a conventional type using electric, gas, heat exchanger, etc. Through experimentation it has been found that a heat transfer to the passing air at a rate of 50,000 BTUs per hour creates a desirable temperature change to increase the drying capabilities of the apparatus 20 and to provide comfort for the individual. Of course, the heater 26 could be placed anywhere along the airflow circuit either prior to the blower or after the blower. Other desirable ranges of BTUs per hour could be 15,000 to 100,000. In some instances were comfort is on an objective the heater could be removed altogether.

In other embodiments a dehumidifier could be employed in the airflow circuit. In a preferred form a dehumidifier would be placed prior to the heater 26 and would withdraw water from the air traveling in the air flow circuit. Therefore, the air striking the individual will have a lower relative humidity hence there will be a greater water vapor gradient that would result in greater evaporation.

Emphasis should be placed on the fact that the apparatus of the present invention does not rely upon evaporation to remove water droplets on the surface of an individual's skin. The apparatus 20 blasts the water off therefore saving the energy that would have been used to evaporate the water droplets.

While the invention is susceptible of various modifications and alternative forms, specific embodiments thereof have been shown by way of example in the drawings and will herein be described in detail. It s should be understood, however, that it is not intended to limit the invention to the particular forms disclosed, but, on the contrary, the intention is to cover all modifications, equivalents and alternatives falling within the spirit and scope of the invention as expressed in the appended claims.

I claim:

1. An apparatus to dry a person with water droplets on the person the apparatus comprising:
an air ejector comprising a slot adapted to eject at a high velocity to dry the person;
blower in communication with the air ejector;
whereas the velocity of the air will partially blow off water droplets on the person.

2. The apparatus in claim 1 further comprising:
a heater adapted to raise the temperature of the air to be ejected from the air ejector.
